(19) United States
(12) Patent Application Publication
(10) Pub. No.: US 2016/0237989 A1
(43) Pub. Date: Aug. 18, 2016

(54) VERTICAL AXIS WIND TURBINES AND RELATED METHODS OF BRAKING

(71) Applicant: University Of Cincinnati, Cincinnati, OH (US)

(72) Inventor: Shaaban Abdallah, Cincinnati, OH (US)

(21) Appl. No.: 15/045,457

(22) Filed: Feb. 17, 2016

Related U.S. Application Data
(60) Provisional application No. 62/117,242, filed on Feb. 17, 2015.

(51) Int. Cl. F03D 7/06; F03D 3/06; F03D 9/00; F03D 3/00

(52) U.S. Cl. CPC F03D 7/06; F03D 3/005; F03D 3/062; F03D 9/002; F03D 9/007

(57) ABSTRACT

An exemplary vertical axis wind turbine includes a support structure rotatable about a vertical turbine axis, and at least two blades each operatively coupled to the support structure and pivotable about a respective blade axis between a fixed working position at which the blade receives a first amount of wind force and generates a torque for rotating the support structure about the turbine axis, and a neutral position at which the blade receives a lesser second amount of wind force. An exemplary method of aerodynamically braking a vertical axis wind turbine includes at least one of inhibiting a blade from reaching the fixed working position, or securing the blade in a position other than the neutral position.

### CROSS-REFERENCE TO RELATED APPLICATION

This application claims priority to U.S. Provisional Application Ser. No. 62/117,242, filed Feb. 17, 2015, the disclosure of which is hereby incorporated by reference herein in its entirety.

### TECHNICAL FIELD

The present invention relates generally to devices and methods for harnessing natural energies, and more particularly, to vertical axis wind turbines.

### BACKGROUND

Ongoing depletion of nonrenewable energy resources, such as petroleum, has fostered a growing need for devices and methods that harness the power of renewable energy resources, including wind. Wind farms generally consist of one or more groupings of wind turbines that each include a rotor having blades that are driven by the wind to rotate about a turbine axis. This mechanical rotation is then converted into electrical energy. Most wind farms consist of horizontal axis wind turbines, which include blades that rotate about a horizontal turbine axis. However, when in close proximity to neighboring turbines, horizontal axis wind turbines suffer from a reduced power coefficient.

This deficiency of horizontal axis wind turbines has driven the development of vertical axis wind turbines. The blades of vertical axis wind turbines span in a direction generally parallel to the wind turbine axis, whereas the blades of horizontal wind turbines span in a direction generally perpendicular to the wind turbine axis. While vertical axis wind turbines are generally mounted such that the wind turbine axis and blade span directions are oriented vertically, vertical axis wind turbines may also be mounted in various other orientations relative to a ground surface, such as horizontal. Accordingly, the term “vertical” as used herein in connection with vertical axis wind turbines and related components is not limiting to a traditional vertical orientation of such components.

Vertical axis wind turbines can be positioned much closer together than horizontal axis wind turbines without negatively impacting performance characteristics to the same degree, or even at all. Consequently, vertical axis wind turbines have the ability to generate as much as ten times more energy per square meter than horizontal axis wind turbines, thereby yielding much higher power outputs per unit of land than horizontal axis wind turbines. Further, vertical axis wind turbines are generally smaller, less intrusive, and cheaper to produce that horizontal axis wind turbines.

Conventional vertical axis wind turbines generally include a plurality of curved blades rigidly fixed to a lower plate, often in the form of a disc, or to a shaft. As the blades rotate with the turbine disc or shaft about a vertical axis of the wind turbine, each blade successively passes back and forth between first and second orientations relative to the wind. In a first orientation relative to the wind, the blade receives the wind force to generate a torque in a first direction about the turbine axis, thereby successfully contributing to ongoing, power-generating rotation of the wind turbine.

As the blade rotates about the vertical turbine axis, it momentarily transitions to a second orientation relative to the wind in which the blade faces “backward” to the wind. In this second orientation, the backward facing blade momentarily generates a counter torque in a second, opposite direction about the turbine axis that resists the positive turbine rotation in the first direction. For example, while a first blade of a vertical axis wind turbine faces toward the wind and generates a positive torque about the turbine axis, a second blade may simultaneously be facing backward relative to the wind and generating a negative counter torque, which may be lesser in quantity that the positive torque. Nevertheless, this counter torque undesirably reduces the efficiency of the turbine in harnessing energy from the wind.

Accordingly, there is a need for improvements to known vertical axis wind turbines to address at least the shortcomings described above.

### SUMMARY

A vertical axis wind turbine according to an exemplary embodiment of the invention includes a support structure rotatable about a turbine axis, and at least two blades, each blade operatively coupled to the support structure and being pivotable about a respective blade axis. Each of the at least two blades is pivotable between a fixed working position at which the blade receives a first amount of wind force and generates a torque for rotating the support structure about the turbine axis, and a neutral position at which the blade receives a lesser second amount of wind force.

In another embodiment, an exemplary method of aerodynamically braking a vertical axis wind turbine is also provided. The method includes obtaining a vertical axis wind turbine including a support structure rotatable about a vertical turbine axis, and at least one blade operatively coupled to the support structure. The at least one blade is pivotable about a blade axis between a fixed working position at which the at least one blade is configured to receive a first amount of wind force and generate a torque for rotating the support structure about the turbine axis, and a neutral position at which the at least one blade is configured to receive a lesser second amount of wind force. The method further includes braking rotation of the support structure about the turbine axis by inhibiting the at least one blade from reaching the fixed working position, such that the at least one blade generates substantially no torque about the turbine axis. Alternatively, or in addition to the inhibiting step, braking rotation of the support structure about the turbine axis may be accomplished by securing the at least one blade in a position other than the neutral position so as to inhibit the at least one blade from generating a net torque about the turbine axis.

Various additional features and advantages of the invention will become more apparent to those of ordinary skill in the art upon review of the following detailed description of one or more illustrative embodiments taken in conjunction with the accompanying drawings. The drawings, which are incorporated in and constitute a part of this specification, illustrate one or more embodiments of the invention and, together with the general description given above and the detailed description given below, serve to explain the one or more embodiments of the invention.

### BRIEF DESCRIPTION OF THE DRAWINGS

FIG. 1 is a perspective view of a vertical axis wind turbine according to an exemplary embodiment of the invention.

FIG. 1A is a top view of the vertical axis wind turbine of FIG. 1, showing a first blade at a fixed working position and a second blade at a neutral position.

FIG. 1B is a top view similar to FIG. 1A, showing pivoting of the first and second blades between fixed working positions and neutral positions while the turbine rotates about a turbine axis.

FIG. 1C is a top view of the vertical axis wind turbine of FIG. 1, showing the blades in a first aerodynamic braking configuration.

FIG. 1D is a top view of the vertical axis wind turbine of FIG. 1, showing the blades in a second aerodynamic braking configuration.

FIG. 2 is a perspective view of a vertical axis wind turbine according to another exemplary embodiment of the invention, in which pivoting of the blades is retrained by cable members.

FIG. 3 is a perspective view of a vertical axis wind turbine according to another exemplary embodiment of the invention, in which portions of the wind turbine are fitted with solar panels.

FIGS. 4A-4F are cross-sectional views of various exemplary shapes defining a cross-sectional shape of a wind turbine blade.

FIG. 5 is a perspective view of a vertical axis wind turbine according to another exemplary embodiment of the invention, in which the pivoting edges of the blades are supported by a turbine shaft.

FIG. 6 is a perspective view of a vertical axis wind turbine according to another exemplary embodiment of the invention similar to the embodiment of FIG. 5.

FIG. 7A is a perspective view of a vertical axis wind turbine according to another exemplary embodiment of the invention, including a plurality of inner blades and plurality of outer blades.

FIG. 7B is a perspective view of a vertical axis wind turbine according to another exemplary embodiment of the invention similar to the embodiment of FIG. 7A.

FIG. 7C is a perspective view of a vertical axis wind turbine according to another exemplary embodiment of the invention similar to the embodiment of FIG. 7A.

FIG. 7D is a perspective view of a vertical axis wind turbine according to another exemplary embodiment of the invention similar to the embodiment of FIG. 7A.

FIG. 8 is a perspective view of a vertical axis wind turbine according to another exemplary embodiment of the invention, including a single turbine blade.

FIG. 9 is a perspective view of an exemplary turbine support frame for supporting a vertical axis wind turbine, shown schematically.

### DETAILED DESCRIPTION

The present invention provides vertical axis wind turbines according to various exemplary embodiments for providing improved efficiency in harnessing wind energy and generating power.

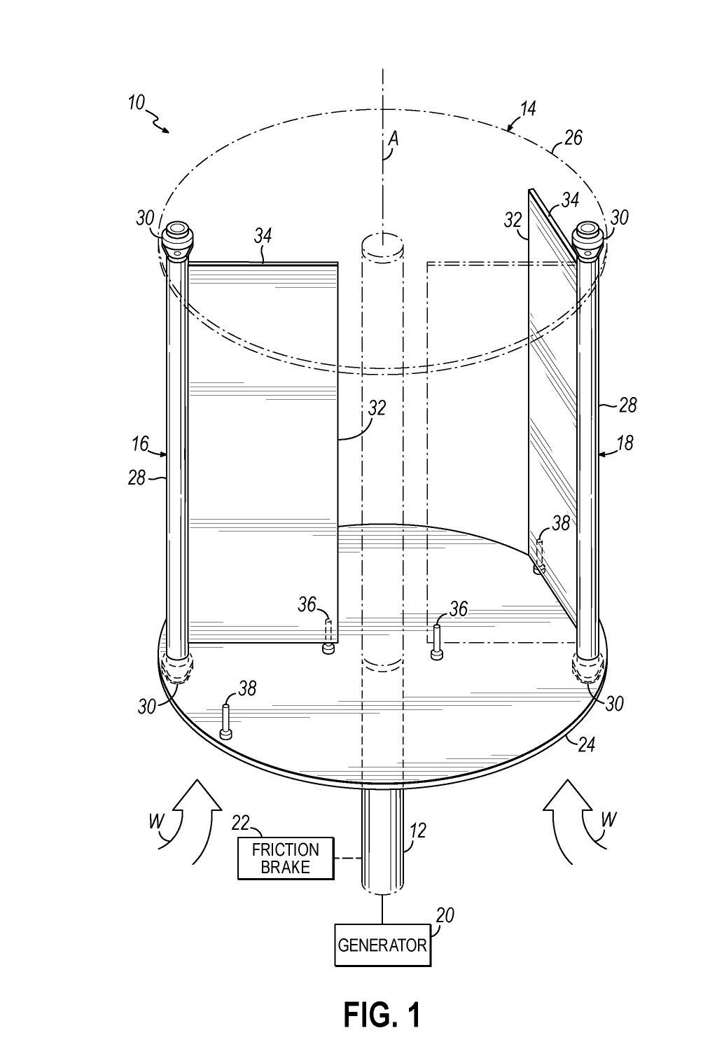

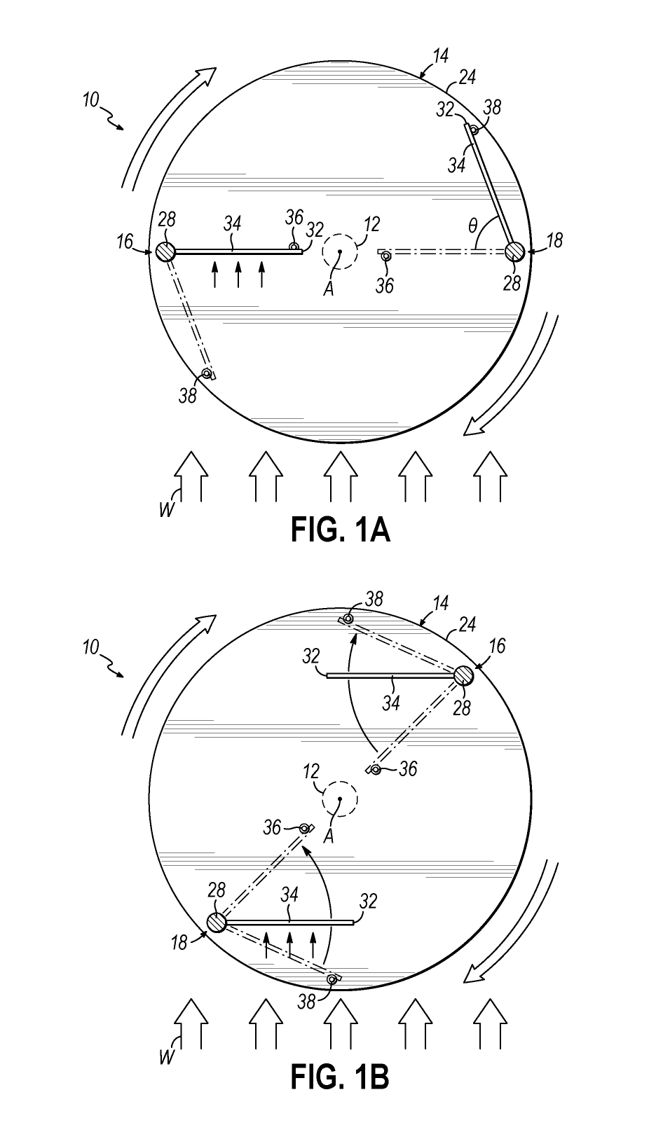

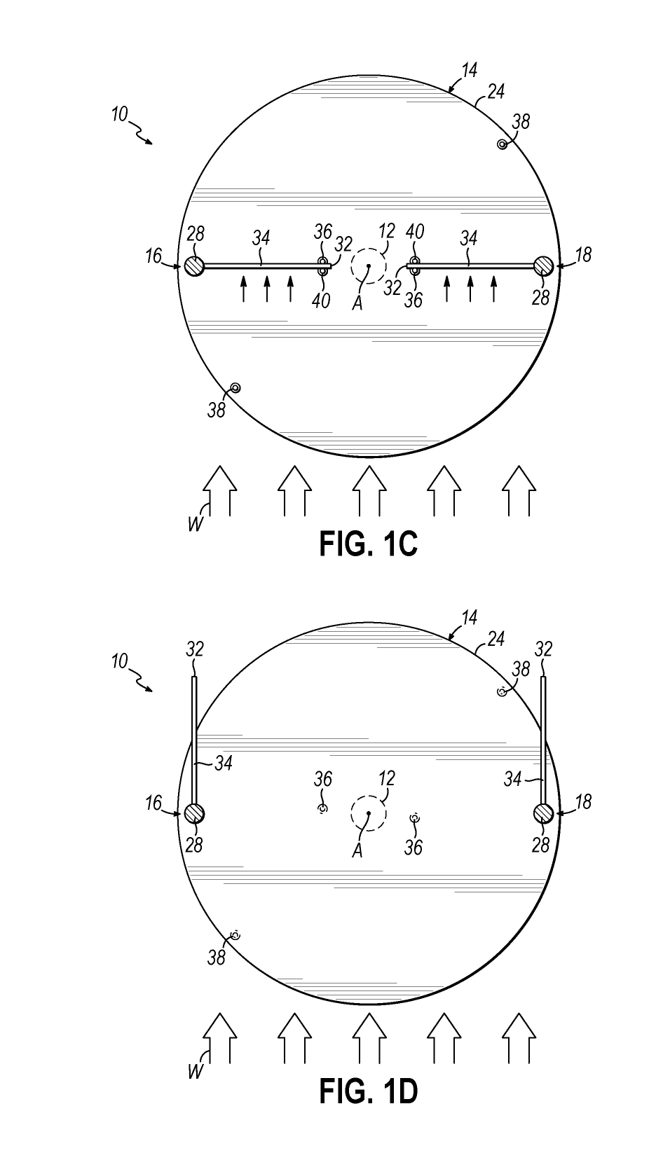

FIGS. 1-1D show a vertical axis wind turbine 10 according to a first exemplary embodiment. The wind turbine 10 generally includes a turbine shaft 12, a blade support structure 14 operatively coupled to the turbine shaft 12, and at least one blade operatively coupled to the support structure 14. The wind turbine 10 is shown having first and second blades 16, 18, though it will be appreciated that additional blades may be provided in alternative embodiments.

The support structure 14 and the turbine shaft 12 are rotatable about a turbine axis A defined by the turbine shaft 12. As described below, each of the blades 16, 18 is configured to receive a wind force exerted by a wind W when in a fixed working position, and thereby generate a torque that rotates the support structure 14 about the turbine axis A. Advantageously, each of the blades 16, 18 pivots about a respective blade axis during rotation of the wind turbine 10, so as to mitigate production of undesirable counter-torques, as described below. The wind turbine 10 may further include a generator 20 for converting rotational mechanical energy of the wind turbine 10 into electrical energy, and a friction brake 22 for selectively braking rotation of the wind turbine 10.

The support structure 14 may include a lower support member 24 and optionally an upper support member 26 (shown in phantom), for supporting respective lower and upper ends of the blades 16, 18. The support members 24, 26 are shown in the Figures in the form of disc-like structures extending generally orthogonally to the turbine axis A. However, it will be appreciated that the support members 24, 26 may be formed with various alternative configurations suitable for supporting the upper and lower ends of the blades 16, 18. For example, the support members 24, 26 may be formed as perforated or otherwise non-solid disc-like structures, or the support members 24, 26 may be formed with various arm-like structures extending radially outward from a central hub, for example.

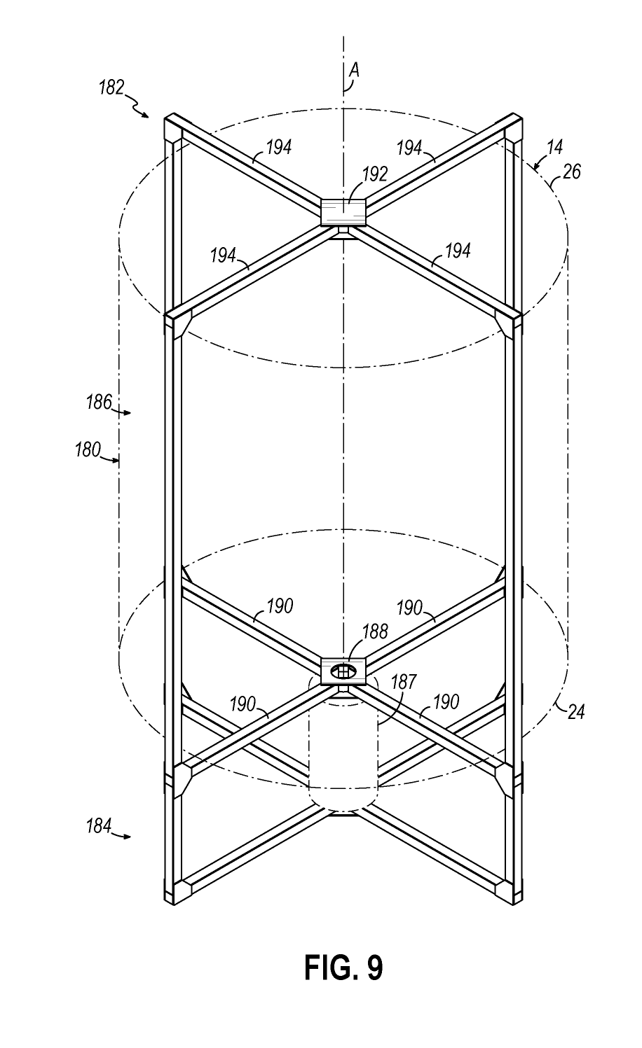

Optionally, the turbine shaft 12 may extend fully between the lower and upper support members 24, 26, as indicated in phantom in FIG. 1. For example, the wind turbine 10 may be mounted vertically relative to a support surface (e.g., a ground surface or building surface) so as to be fully supported near the lower support member 24. In that case, the turbine shaft 12 may include a first shaft portion that extends fully between the upper and lower support members 24, 26, and a second shaft portion that extends outwardly from the lower support member 24 for supporting the wind turbine 10. In another exemplary embodiment (not shown), the wind turbine 10 may be mounted relative to a ground surface (e.g., vertically or horizontally) so as to be supported near both the upper and the lower support members 24, 26. In that case, the turbine shaft 12 may include a first shaft portion that extends outwardly from the lower support member 24, and a second shaft portion that extends outwardly from the upper support member 26, without a shaft portion that extends between the upper and lower support members 24, 26. In such case, the upper and lower support members 24, 26 may be connected by the blades 16, 18. In both embodiments, the wind turbine 10 may be supported at the one or more shaft portions extending outwardly from the support members 24, 26, for example as described in greater detail below in connection with FIG. 9.

Still referring to FIGS. 1-1D, and in particular to FIG. 1, each of the turbine blades 16, 18 may include an elongate blade strut 28 that defines a respective blade axis about which the blade 16, 18 pivots relative to the support structure 14. For example, each blade 16, 18, via its blade strut 28, may be pivotably coupled to the upper and lower support members 24, 26 with bearing units 30. As shown in the Figures, the blades 16, 18 may be mounted such that their blade struts 28 and corresponding blade axes extend generally parallel to the turbine axis A. In alternative embodiments, the blades 16, 18 may be mounted such that their blade axes are angled relative to the turbine axis A.

As shown, each blade strut 28 may extend for the full span of its respective blade 16, 18, though the struts 28 may be formed with various other configurations in alternative embodiments. For example, each blade strut 28 may be formed with upper and lower strut portions that extend outwardly from respective upper and lower ends of the blade 16, 18. Furthermore, it will be appreciated that in place of traditional struts, a blade 16, 18 may be provided with various other suitable mechanical features that extend fully or partially along the blade span and enable pivoting of the blade 16, 18 about the blade axis relative to the support structure 14. In that regard, it will be further appreciated that the blades 16, 18 may be operatively coupled to the support structure 14 in a variety of manners using known mechanical coupling components suitable to enable the blade pivoting motions described herein.

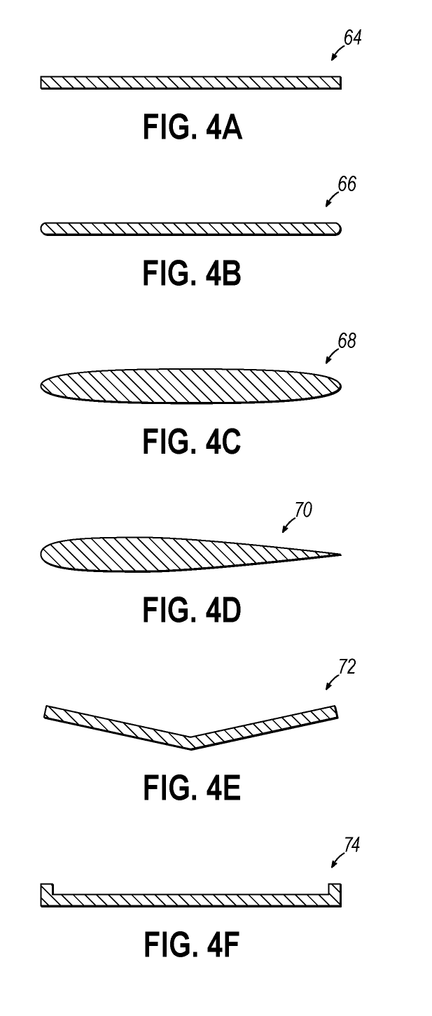

Each turbine blade 16, 18 includes a free edge 32 that extends away from the respective blade axis and defines a blade chord 34 extending transverse to the blade axis. Each blade 16, 18 is shown in the Figures in the form of a rectangular plate having a free edge 32 that extends generally parallel to the blade axis, so as to define a chord 34 of constant length. However, it will be appreciated that the blades 16, 18 may be formed with various other shapes, and with chords 34 of varying length, suitable to achieve desired wind turbine performance characteristics. As described below in connection with FIGS. 4A-4F, each blade 16, 18 may be formed with a transverse cross-section of various shapes.

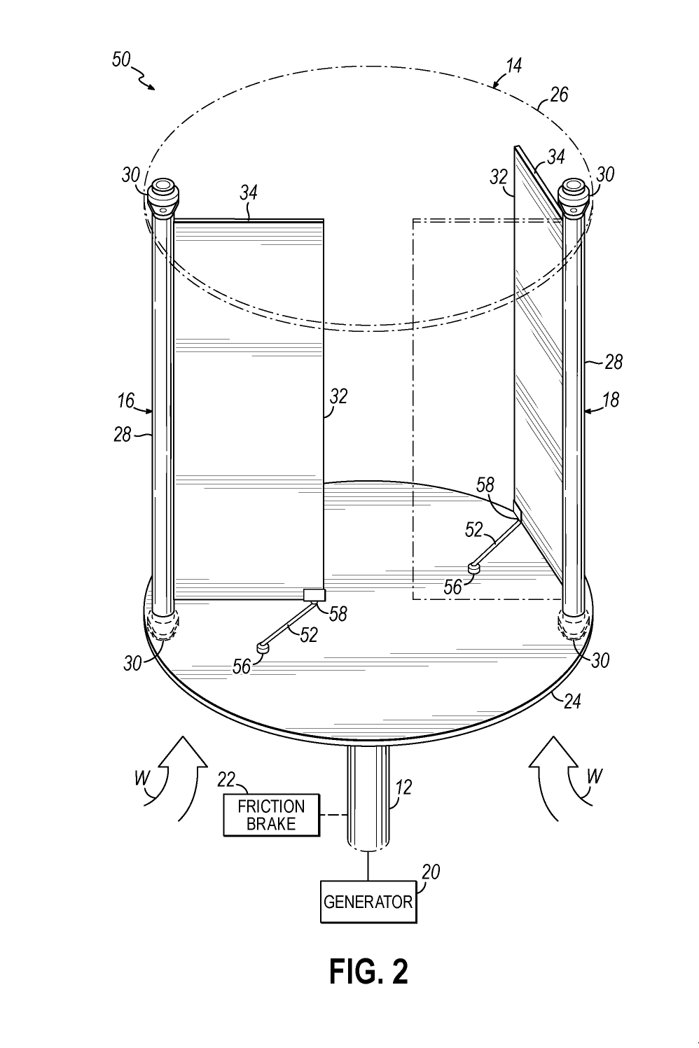

Each blade 16, 18 may be restrained at its fixed working position by a first blade stop member shown in the form of working position pin 36, and optionally at its neutral position by a second blade stop member shown in the form of neutral position pin 38. The pins 36, 38 may be anchored to and project upwardly from the lower support member 24 of the support structure 14 to engage corresponding lower portions of the blades 16, 18. As such, placement of the pins 36, 38 relative to the support structure 14 defines the working and neutral positions of the blades 16, 18. Although not shown, corresponding sets of blade stop members may also be provided on the upper support member 26 to engage upper portions of the blades 16, 18. Moreover, it will be appreciated that the blade stop members may take various alternative forms suitable to inhibit pivoting of the blades 16, 18, for example as described below in connection with FIG. 2.

In the embodiment of FIGS. 1-1D, the blade axes are spaced from the turbine axis A such that when each blade 16, 18 is at its fixed working position, its free edge 32 is positioned radially inward of its blade axis. In other words, each blade 16, 18 is mounted to the lower support member 24 such that its free edge 32 is oriented generally toward the turbine shaft 12 when at the fixed working position. To achieve this configuration, the blade struts 28 defining the blade axes may be positioned near an outer periphery of the lower support member 24. In exemplary embodiments, each blade axis may be spaced radially outward from the turbine axis A by a distance greater than a length of the blade chord 34. Moreover, the blade axes may be spaced radially equidistant from the turbine axis A, and with uniform circumferential spacing about the turbine axis A. While only first and second blades 16, 18 are shown, it will be appreciated that various alternative quantities of blades may be provided, wherein the blades are mounted with uniform spacings in radial and circumferential directions.

As the wind turbine 10 rotates about the turbine axis A, each blade 16, 18 freely pivots about its respective blade axis between a fixed working position and a neutral position. This pivoting motion may be induced fully by a force exerted by the wind W, and unassisted by an actuating device such as a motor. Referring to FIGS. 1 and 1A, the wind turbine 10 is shown in an exemplary first rotational position about the turbine axis A, in which the first blade 16 is oriented at an exemplary fixed working position and the second blade 18 is oriented at an exemplary neutral position. When at the fixed working position, a blade 16, 18 receives a first amount of wind force and thereby generates a torque for rotating the support structure 14 about the turbine axis A, as indicated by directional arrows in FIG. 1A. When at the neutral position, a blade 16, 18 is oriented relative to the wind force direction such that the blade 16, 18 receives a lesser second amount of wind force, such as no wind force, for example. Thus, to the extent that the blade 16, 18 at the neutral position generates any counter-torque about the turbine axis A, the counter-torque is significantly less than the torque generated in the opposite direction by the blade 16, 18 at the fixed working position. In this manner, a power generation process using wind turbine 10 is kept highly efficient.

It will be appreciated that the radial spacing of the blade axis from the turbine axis A, in combination with the length of the chord 34, determines a torque arm distance of the blade 16, 18 relative to the turbine axis A. In that regard, it will be further appreciated that the span (e.g., height) of the blade 16, 18, in combination with the torque arm distance, determines the amount of torque generated by the blade 16, 18 about the turbine axis A when the blade 16, 18 is acted upon by a wind W. As such, the blade chord length, blade span, and the radial spacing of the blade axis from the turbine axis A may be selectively adjusted to tune performance characteristics of the wind turbine 10.

As shown in FIG. 1A, each of blades 16 and 18 moves between a fixed working position and a neutral position. In the fixed working position, as shown by first blade 16 in FIGS. 1 and 1A, the blade chord 34 forms a working position angle relative to a radial line extending from the turbine axis A to the blade axis (the working position angle is not indicated by reference numeral in the Figures due to an exemplary illustrated angle of zero degrees). Similarly, in the neutral position, as shown by second blade 18 in FIGS. 1 and 1A, the blade chord 34 forms a neutral position angle 0 relative to a radial line extending from the turbine axis A to the blade axis. In various embodiments, the fixed working position and the neutral position are defined such that the neutral position angle 0 is greater than the working position angle. This relationship ensures that a blade 16, 18 at the neutral position is exposed to less wind force than a blade 16, 18 restrained at the fixed working position. Consequently, and advantageously, any counter-torques otherwise produced by the blades 16, 18 about the turbine axis A during rotation of the wind turbine 10 are substantially reduced, if not entirely eliminated.

As shown in FIG. 1A, each working position pin 36 is located on the lower support member 24 so as to define a fixed working position of the blade 16, 18. In the exemplary embodiment shown, each working position pin 36 is located so as to define a fixed working position at which the blade chord 34 extends toward and aligns with the turbine axis A, thereby forming an exemplary working position angle of zero degrees. By comparison, each neutral position pin 38 is located on the lower support member 24 so as to form an exemplary neutral position angle 0 that is acute (i.e., larger than the working position angle).

In alternative embodiments, the working position pins 36 and neutral position pins 38 may be repositioned to various other locations on the lower support member 24 to define various other working position angles and neutral position angles 0, wherein the neutral position angle 0 is larger than the working position angle. In one embodiment, the neutral position pins 38 may be relocated, or even removed, so as to define a neutral position angle 0 of approximately 90 degrees (i.e., the blade chord 34 being parallel to the wind force direction), for example. In such case, the wind force received by the blade 16, 18 at the neutral position, and the resulting torque generated by the blade 16, 18 about the turbine axis A, is approximately zero.

In operation, the wind turbine 10 is subjected to a wind W having a direction. Depending on the starting rotational orientation of the wind turbine 10 relative to the wind direction, the wind W forces one of the blades 16, 18 to pivot to its fixed working position, and the other of the blades 16, 18 to pivot to its neutral position. For example, as shown in FIG. 1A, the wind W may force the first blade 16 to pivot into the fixed working position against the respective working position pin 36, and force the second blade 18 to pivot into the neutral position against the respective neutral position pin 38. In this configuration, the first blade 16 receives the wind force and thereby generates a torque about the turbine axis A in a first direction, indicated by the directional arrows. Advantageously, because the second blade 18 is less exposed to the wind W than the first blade 16, the second blade 18 produces very little, if any, counter-torque that resists the torque generated by the first blade 16. As a result, the wind turbine 10 may rotate about the turbine axis A with minimal resistance and optimal efficiency. Further, the ability of the blades 16, 18 to freely and independently pivot when exposed to a wind W allows the wind turbine 10 to self-start without assistance provided by external devices, such as a starter motor.

As shown in FIG. 1B, the wind turbine 10 has rotated more than 90 degrees from its position in FIG. 1A in which the first blade 16, restrained at its fixed working position, was oriented perpendicular to the direction of the wind W. As a result, as shown in FIG. 1B, the sides of the blades 16, 18 now exposed to the wind W are opposite from the sides exposed to the wind in the position of FIG. 1A. As a result, the wind W now forces the first blade 16 to pivot toward its respective neutral position pin 38, and forces the second blade 18 to pivot toward its respective working position pin 36. As the wind turbine 10 continues to rotate, the second blade 18 pivots fully to its fixed working position and the first blade 16 pivots fully to its neutral position. As the wind turbine 10 further rotates past an additional 90 degrees from the rotational position at which the second blade 18 is perpendicular to the wind direction, the first and second blades 16, 18 again begin to pivot back toward their original working or neutral positions. In this manner, the first and second blades 16, 18 freely oscillate between fixed working positions and neutral positions as the wind turbine 10 continues to rotate about the turbine axis A.

As each blade 16, 18 pivots to its neutral position, the blade 16, 18 contacts and thereby exerts an impact force on its respective neutral position pin 38. In embodiments similar to that of FIGS. 1-1D in which the blade axes are spaced from the turbine axis A such that the free edges 32 of the blades 16, 18 are positioned radially inward of their respective blade axes, the impact force exerted on the neutral position pin 38 advantageously generates a secondary torque about the wind turbine axis A that enhances the primary torque generated by the blade 16, 18 in the fixed working position. In exemplary embodiments, this secondary torque may enhance the primary torque by up to 40%, for example. The amount of secondary torque generated may be adjusted by repositioning the neutral position pins 38 on the lower support member 24. Alternatively, as described above, the neutral position pins 38 may be removed or otherwise omitted from the wind turbine 10, such that the blades 16, 18 freely pivot to neutral positions that are parallel to the wind direction. In such case, the blades 16, 18 do not generate secondary torques when pivoting to their neutral positions.

Referring to FIGS. 1C and 1D, two exemplary methods of aerodynamically braking the wind turbine 10 are shown. These methods may be used in combination with, or in substitute for, frictional braking provided by the friction brake 22. In that regard, the friction brake 22 may be any suitable friction braking device known in the art that engages the turbine shaft 12 or either of the upper and lower support members 24, 26, for example.

Referring to FIG. 1C, a first exemplary method of aerodynamically braking the wind turbine 10 includes securing each of the blades 16, 18 in their fixed working positions, each blade 16, 18 forming a similar working position angle. The wind turbine 10 is oriented rotationally such that each secured blade 16, 18 contacts the wind at the same angle, and thus receives the same amount of wind force. For example, as shown in FIG. 1C, the wind turbine 10 is oriented such that both blades 16, 18 are perpendicular to the wind direction. Consequently, each blade 16, 18 generates an equal and opposite torque about the turbine axis A, such that the blades 16, 18 collectively generate a net torque of zero. As a result, the wind turbine 10 does not rotate in either direction. However, it will be appreciated that if the wind W momentarily shifts direction so as to exert a greater force on one of the blades 16, 18 than the other, a torque will be generated about the turbine axis A, which may cause the wind turbine 10 to rotate such that the blades 16, 18 become parallel to the new wind direction.

Still referring to FIG. 1C, the blades 16, 18 may be secured using an additional set of blade stop members shown in the form of pins 40, which may cooperate with the working position pins 36 to clamp the blades 16, 18 in their fixed working positions. In alternative embodiments, the additional blade stop members may include various other mechanical devices suitable to engage and inhibit the blades 16, 18 from pivoting.

While the blades 16, 18 are shown secured in exemplary fixed working positions forming working position angles of zero degrees, the blades 16, 18 may be secured in any desired pivot position other than the neutral position, provided that both blades 16, 18 are similarly oriented. For example, both blades 16, 18 may be secured in a pivot position that is between the exemplary fixed working position and neutral position shown in FIGS. 1-1B.

Referring to FIG. 1D, a second exemplary method of aerodynamically braking the wind turbine 10 includes inhibiting each of the blades 16, 18 from reaching a fixed working position at which either blade receives the wind force and generates a torque about the turbine axis A. More specifically, the blade stop pins 36, 38, or other blade stop members, may be manipulated or removed to allow each of the blades 16, 18 to pivot so that the blade chords 34 become parallel to the wind direction. As a result, neither blade 16, 18 generates a torque about the turbine axis A, and the wind turbine 10 does not rotate. Advantageously, because the blades 16, 18 in this braking embodiment are not being restrained in a position in which they generate a torque, the components of the wind turbine 10 are not stressed.

Referring to FIG. 2, a vertical axis wind turbine 50 according to another exemplary embodiment of the invention is shown. The wind turbine 50 is largely similar in structure and function to wind turbine 10 of FIG. 1, as indicated by use of similar reference numerals in FIG. 2. However, wind turbine 50 includes blade stop members in the form of tethers 52, 54. Each tether 52, 54 has a first end 56 anchored to the lower support member 24, and a second end 58 coupled to the respective blade 16, 18, for example at a lower corner of the blade 16, 18 near the free edge 32. In embodiments in which the wind turbine 50 includes an upper support member 26, an additional set of tethers (not shown) may be provided to couple the upper portions of the blades 16, 18 to the upper support member 26. These upper tethers may be mounted to the blades 16, 18 and the upper support member 26 in a manner similar to that described in connection with the lower tethers 52, 54.

Each tether 52, 54 restrains the respective blade 16, 18 at both its fixed working position and at its neutral position. Accordingly, a length of the tether 52, 54 and a location at which the first end 56 is anchored to the lower support member 24 may be selected as desired to define the fixed working position and the neutral position. It will be appreciated that the location at which the first end 56 is mounted to the lower support member 24 may define a middle point in the pivoting range of the blade 16, 18 between the fixed working position and the neutral position.

In an exemplary embodiment, either or both of the tethers 52, 54 may be selectively adjustable in length, for example at the first end 56 or at the second end 58, for adjusting the working position angle and the neutral position angle (see FIG. 1A) of the respective blade 16, 18. Adjustment of the tether length may be performed manually or automatically, for example with assistance of a powered drive. Further, one or both of the tethers 52, 54 may be selectively lengthened to allow the first and second blades 16, 18 to pivot to become parallel with the wind direction, thereby achieving an aerodynamic braking effect similar to that described above in connection with FIG. 1D. In another exemplary embodiment, one or both of the tethers 52, 54 may be selectively releasable at the first end 56, the second end 58, or a location therebetween, to achieve a similar aerodynamic braking effect.

Advantageously, the tethers 52, 54 may enable quieter operating conditions than the blade stop pins 36, 38 provided on wind turbine 10. When blades 16, 18 of wind turbine 50 pivot to their fixed working position or neutral position, they exert a tension force on the tethers 52, 54. This application of tension on the tethers 52, 54 may produce a quieter noise, if any, compared to the noise of the blades 16, 18 contacting the pins 36, 38 of wind turbine 10.

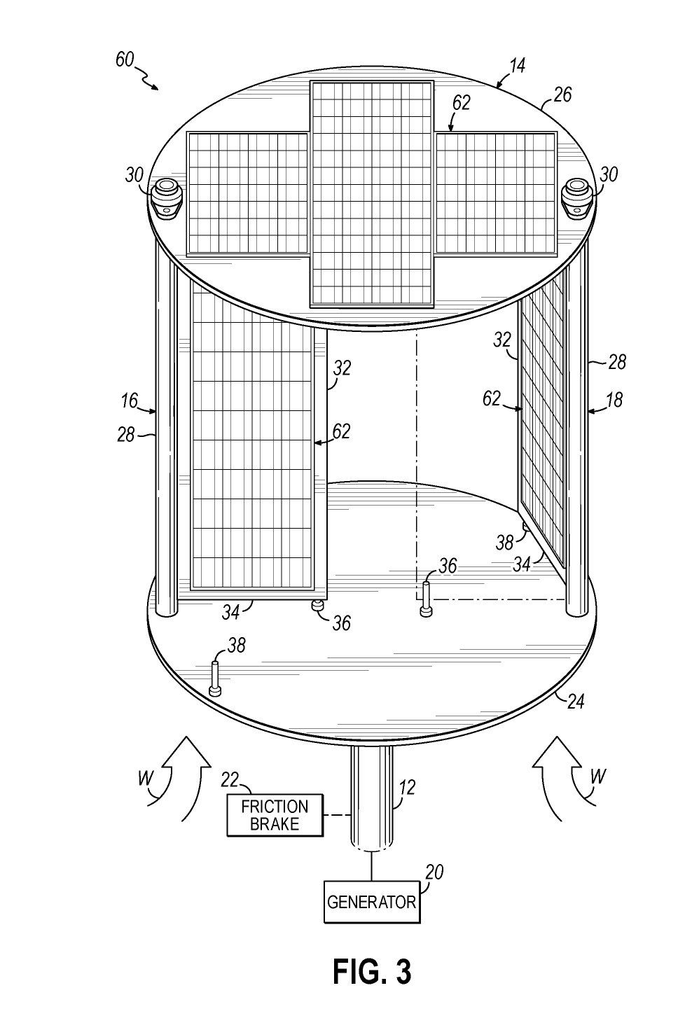

Referring to FIG. 3, a vertical axis wind turbine 60 according to another exemplary embodiment of the invention is shown. The wind turbine 60 is largely similar in structure and function to wind turbine 10 of FIG. 1, as indicated by use of similar reference numerals in FIG. 3. As shown, the wind turbine 60 includes a plurality of solar panels 62 mounted to various portions of the wind turbine 60. In particular, the solar panels 62 may be mounted to the side surfaces of the first and second blades 16, 18, and to a top surface of the upper support member 26. It will be appreciated that the solar panels 62 may be mounted to various other surfaces of the wind turbine 60, depending on the orientation in which the wind turbine 60 is to be supported relative to the sun. The solar panels 62 may be electrically connected to an electrical storage bank (not shown) for storing electrical energy produced by the solar panels 62.

Each turbine blade of the various exemplary wind turbines disclosed herein may be formed with a transverse cross-section selected from a variety of shapes, such any one or combination of those shown in FIGS. 4A-4F, for example. FIG. 4A shows a first exemplary blade cross-section 64 having a generally rectangular shape, which defines a turbine blade in the form of a generally flat plate. FIG. 4B shows a second exemplary blade cross-section 66 having a generally rectangular shape similar to that of blade cross-section 64 of FIG. 4A, but including rounded ends. FIG. 4C shows a third exemplary blade cross-section 68 having a generally oblong or oval-like shape. FIG. 4D shows a fourth exemplary blade cross-section 70 having a symmetrical airfoil shape. FIG. 4E shows a fifth exemplary blade cross-section 72 having a generally V-like shape. FIG. 4F shows a sixth exemplary blade cross-section 74 having a generally rectangular shape with upwardly turned ends. It will be appreciated that the particular cross-section of the blades may be selected to optimize wind turbine performance in view of specific operating conditions.

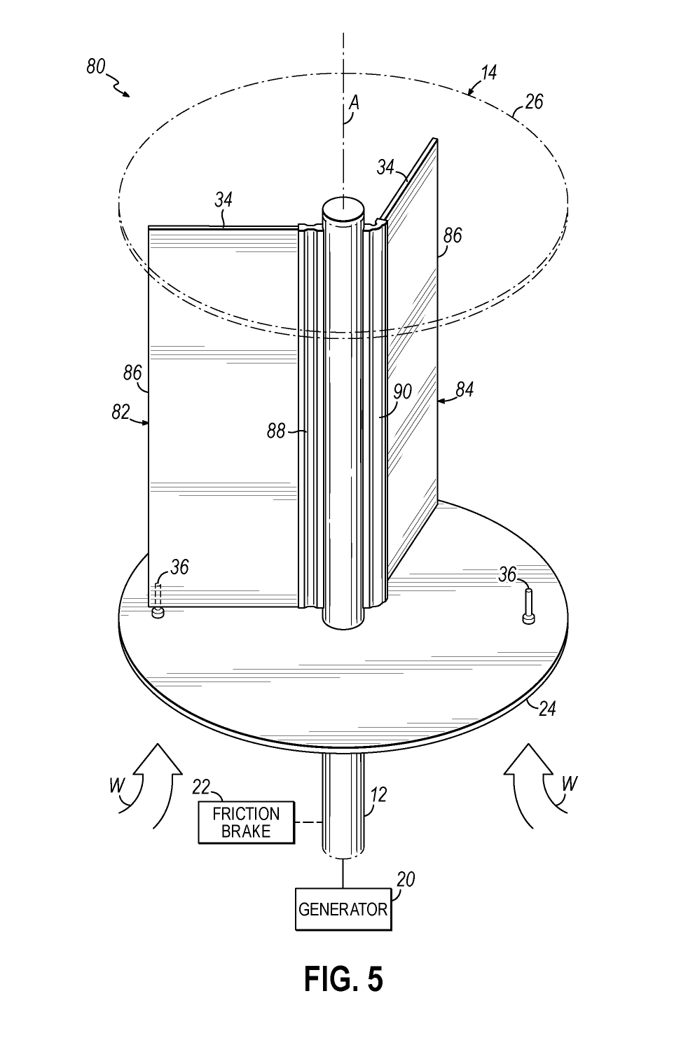

Referring to FIG. 5, a vertical axis wind turbine 80 according to another exemplary embodiment of the invention is shown. The wind turbine 80 is generally similar in structure to wind turbine 10 of FIG. 1, as indicated by use of similar reference numerals in FIG. 5, except as otherwise described below.

Unlike wind turbine 10, wind turbine 80 includes first and second blades 82, 84 having respective blade axes that are positioned relative to the turbine axis A such that when the blade 82, 84 is at its fixed working position, its free edge 86 is positioned radially outward of its blade axis. In other words, each blade 82, 84 is mounted such that its free edge 86 is oriented generally away the turbine shaft 12 when at the fixed working position. In the exemplary embodiment shown in FIG. 5, each blade 82, 84 is hingedly connected to and supported by the turbine shaft 12. In particular, the first blade 82 is supported by a first hinge 88 that defines the blade axis about which the first blade 82 pivots, and the second blade 84 is supported by a second hinge 90 that defines the blade axis about which the second blade 84 pivots. In alternative embodiments, the blades 82, 84 may include struts (e.g., similar to struts 28) instead of hinges 88, 90, the struts being pivotably coupled to the support structure 14 at positions slightly radially outward from the turbine shaft 12.

As shown in FIG. 5, the hinges 88, 90 and blades 82, 84 may be positioned at generally diametrically opposite positions on the turbine shaft 12. While only two blades 82, 84 are shown, additional blades may be provided in alternative embodiments. Further, the wind turbine 80 may additionally include working position pins 36 for defining the fixed working positions of the blades 82, 84. The wind turbine 80 may be formed without neutral position pins 38, so as to permit the blades 82, 84 to pivot to a neutral position parallel with the wind direction without contacting a blade stop member. Because each blade 82, 84 is mounted such that its free edge 86 is positioned radially outward of its blade axis, the blades 82, 84 pivot from the fixed working position to the neutral position in a direction opposite the direction of rotation of the wind turbine 80 about the turbine axis A. Accordingly, if neutral position pins were included on wind turbine 80, the blades 82, 84 could contact them at the neutral position to generate a secondary torque about the turbine axis A that undesirably opposes the primary torque generated by the blades 82, 84 at the fixed working position.

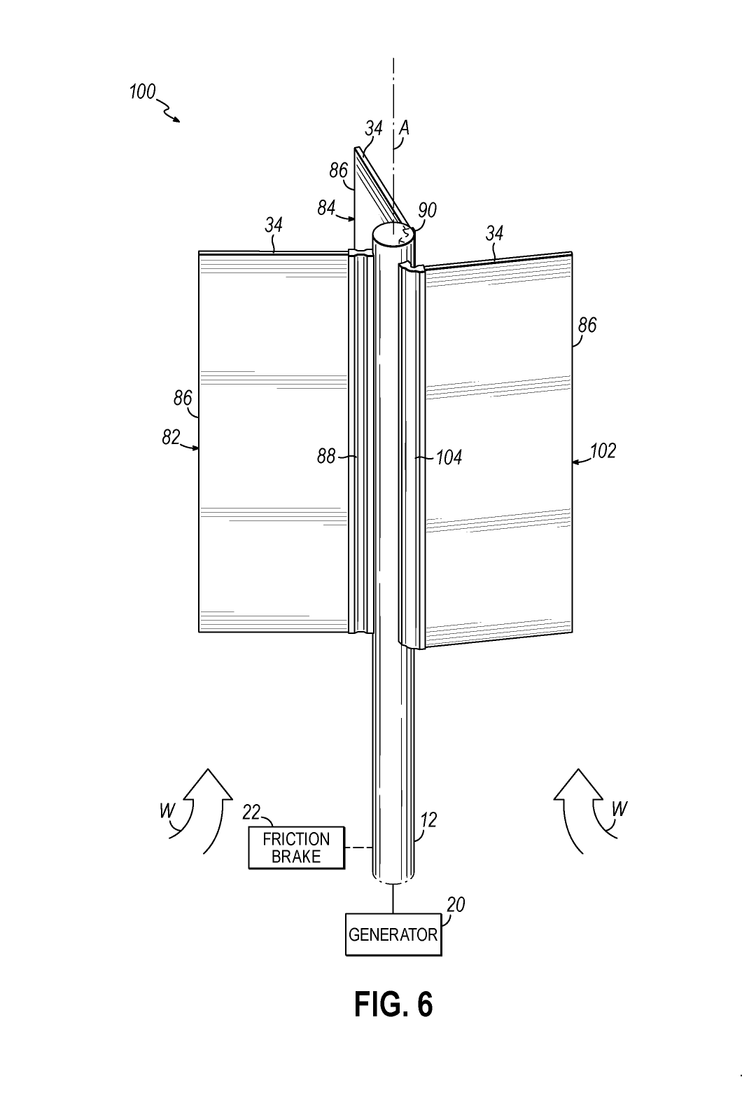

Referring to FIG. 6, a vertical axis wind turbine 100 according to another exemplary embodiment of the invention is shown. The wind turbine 100 is generally similar in structure to wind turbine 80 of FIG. 5, as indicated by use of similar reference numerals in FIG. 6, as except as otherwise described. In particular, the wind turbine 100 includes a third blade 102 hingedly connected to and supported by the turbine shaft 12 with a third hinge 104. As shown, the blades 82, 84, 102 are equally spaced circumferentially about the turbine shaft 12. Furthermore, the upper and lower support members 24, 26 may be omitted from the wind turbine 100, so that each blade 82, 84, 102 may pivot a full range permitted by its respective hinge 88, 90, 104, without contacting a blade stop member. As such, it will be appreciated that the fixed working position of each blade 82, 84, 102 is defined by the degree to which the hinge 88, 90, 104 permits the blade 82, 84, 102 to pivot. The hinges 88, 90, 104 may be formed with various features suitable to limit the pivot ranges of the blades 82, 84, 102 as desired.

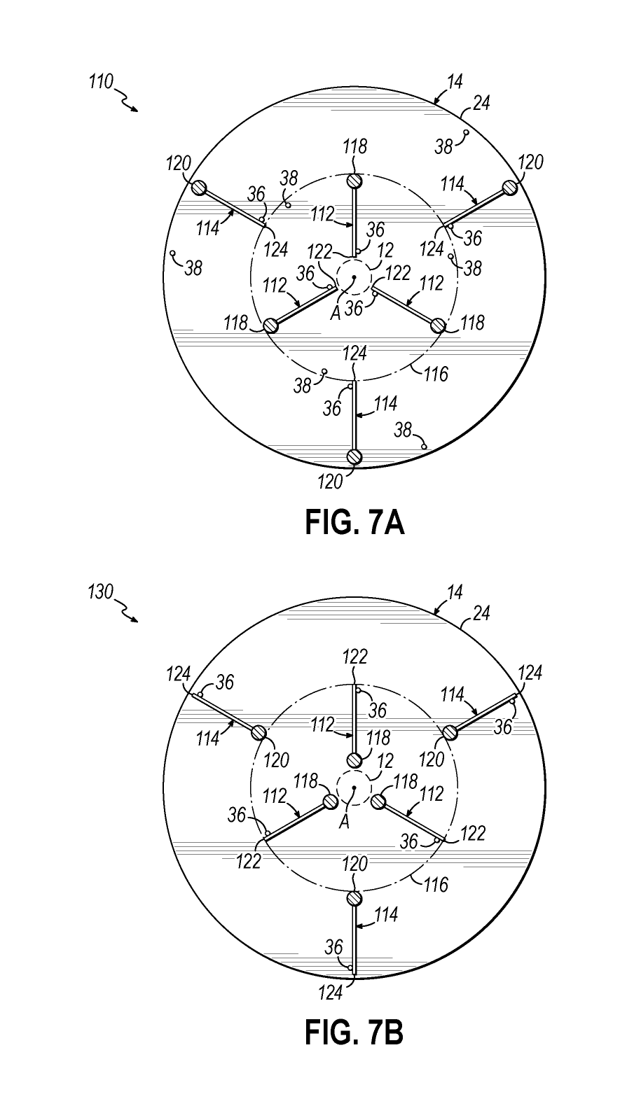

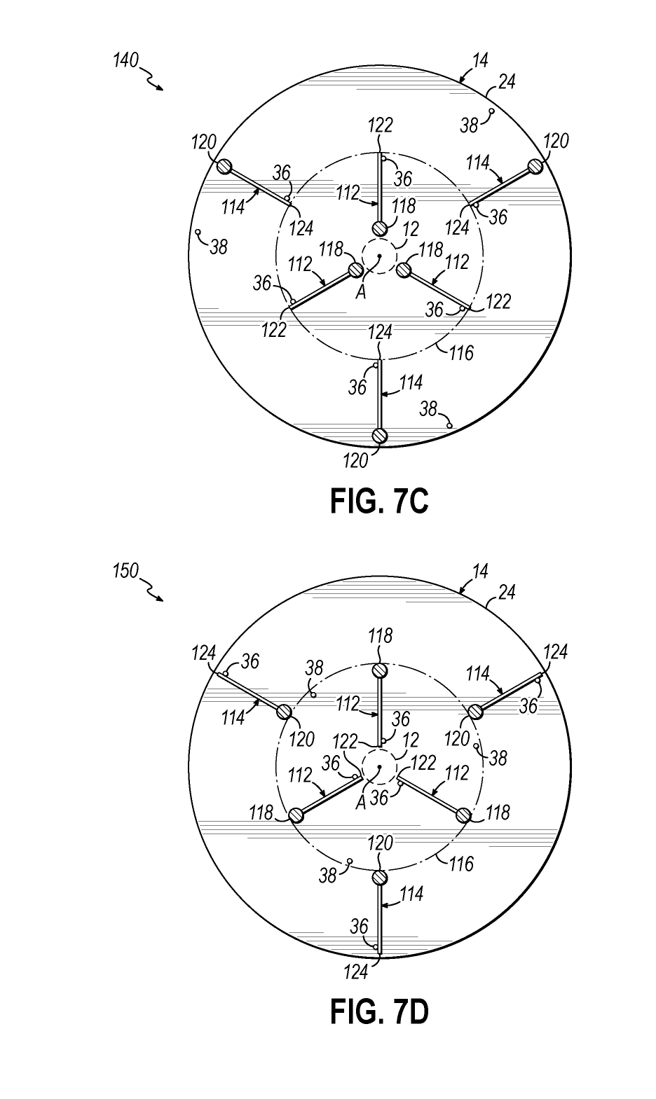

Referring to FIGS. 7A-7D, vertical axis wind turbines according to additional exemplary embodiments of the invention are shown. Each wind turbine includes a plurality of inner blades 112 and a plurality of outer blades 114 positioned radially outward of the inner blades 112. While each wind turbine is shown having blades supported by only a lower support member 24, it will be appreciated that an upper support member 26 may also be provided.

Referring to FIG. 7A, an exemplary vertical axis wind turbine 110 includes three inner blades 112 circumferentially spaced about the turbine shaft 12, and three outer blades 114 positioned radially outward of the inner blades 112 and also circumferentially spaced about the turbine shaft 12. As shown, the outer blades 114 may be positioned so as to not extend radially inward of a circular border 116 defined by the radially outermost portions of the circumferentially arranged inner blades 112.

Each of the inner blades 112 includes an inner blade strut 118 defining a respective inner blade axis about which the inner blade 112 pivots. Similarly, each of the outer blades 114 includes an outer blade strut 120 defining a respective outer blade axis about which the outer blade 114 pivots. In the exemplary embodiment of FIG. 7A, the inner blade struts 118 are spaced radially outward from the turbine shaft 12, generally along the circular border 116, such that free edges 122 of the inner blades 112 are positioned radially inward of their respective inner blade axes when at the respective fixed working positions. Additionally, the outer blade struts 120 are spaced radially outward from the circular border 116, near a periphery of the lower support member 24, such that free edges 124 of the outer blades 114 are positioned radially inward of their respective outer blade axes, and generally along the circular border 116, when at the respective fixed working positions. As such, both the inner blades 112 and the outer blades 114 are mounted to the lower support member 24 such that their free edges 122, 124 are oriented generally toward the turbine shaft 12 when the blades 112, 114 are at their fixed working positions.

With the configuration of FIG. 7A, it will be appreciated that the plurality of inner blades 112 and the plurality of outer blades 114 each pivot between fixed working positions and neutral positions in a manner generally similar to that described above in connection with wind turbine 10 of FIG. 1. In that regard, because each inner blade 112 and outer blade 114 is mounted such that its free edge 122, 124 is oriented generally toward the centrally positioned turbine shaft 12, each blade 112, 114 pivots from its fixed working position to its neutral position in the same direction as the rotation of the wind turbine 110 about the turbine axis A.

Further, as shown in FIGS. 7A-7D, each inner blade 112 and outer blade 114 may cooperate with one or more respective blade stop members that define the fixed working position and, optionally, the neutral position for the blade 112, 114. While the blade stop members are shown in the form of working position pins 36 and neutral position pins 38, alternatively various other blade stop structures may be used, such as tethers 52, 54 shown in FIG. 2, for example.

Referring to FIG. 7B, a vertical axis wind turbine 130 according to an exemplary alternative embodiment is shown. The wind turbine 130 is generally similar to wind turbine 110 of FIG. 7A, as indicated by use of similar reference numerals in FIG. 7B, except as otherwise described. In particular, unlike wind turbine 110, the inner blades 112 and the outer blades 114 of wind turbine 130 are mounted such that their free edges 122, 124 are oriented generally away from the turbine shaft 12 when at the respective fixed working positions. More specifically, the inner blades 112 are mounted such that their free edges 122 are positioned radially outward of their respective inner blade axes. Similarly, the outer blades 114 are mounted such that their free edges 124 are positioned radially outward of their respective outer blade axes. The outer blade struts 120 may be positioned generally along the circular border 116, while the inner blade struts 118 may be positioned adjacent to the turbine shaft 12. In alternative embodiments, the inner blades 112 may be supported directly on the turbine shaft 12 with hinge-like structures similar to those described above in connection with FIG. 5, for example.

With the configuration of FIG. 7B, it will be appreciated that the plurality of inner blades 112 and the plurality of outer blades 114 may each pivot between fixed working positions and neutral positions in a manner generally similar to that described above in connection wind turbine 80 of FIG. 5. In that regard, because each inner blade 112 and outer blade 114 is mounted such that its free edge 122, 124 is oriented generally away from the centrally positioned turbine shaft 12, each blade 112, 114 pivots from its fixed working position to its neutral position in a direction opposite the direction of rotation of the wind turbine 130 about the turbine axis A.

Referring to FIG. 7C, a vertical axis wind turbine 140 according to yet another exemplary alternative embodiment is shown. The wind turbine 140 generally combines the configuration of inner blades 112 of wind turbine 130 of FIG. 7B, with the configuration of outer blades 114 of wind turbine 110 of FIG. 7A, as indicated by use of similar reference numerals in FIG. 7C. Thus, the wind turbine 140 includes inner blades 112 that are mounted such that their free edges 122 are oriented generally away from the turbine shaft 12 when at their fixed working positions, and outer blades 114 that are mounted such that their free edges 124 are oriented generally toward the turbine shaft 12 when at their fixed working positions. As such, the outer blades 114 pivot from their fixed working positions to their neutral positions in a first direction that is the same as the direction of rotation of the wind turbine 140 about the turbine axis A. In contrast, the inner blades 112 pivot from their fixed working positions to their neutral positions in a second direction that is opposite the direction of rotation of the wind turbine 140 about the turbine axis A.

Referring to FIG. 7D, a vertical axis wind turbine 150 according to yet another exemplary alternative embodiment is shown. The wind turbine 150 includes blades 112, 114 arranged in an opposite configuration of wind turbine 140 of FIG. 7C. In that regard, wind turbine 150 of FIG. 7D combines the configuration of inner blades 112 of wind turbine 110 of FIG. 7A, with the configuration of outer blades 114 of wind turbine 150 of FIG. 7B, as indicated by use of similar reference numerals in FIG. 7D. Thus, the wind turbine 150 includes inner blades 112 that are mounted such that their free edges 122 are oriented generally toward the turbine shaft 12 when at their fixed working positions, and outer blades 114 that are mounted such that their free edges 124 are oriented generally away the turbine shaft 12 when at their fixed working positions. As such, the inner blades 112 pivot from their fixed working positions to their neutral positions in a first direction that is the same as the direction of rotation of the wind turbine 150 about the turbine axis A. In contrast, the outer blades 114 pivot from their fixed working positions to their neutral positions in a second direction that is opposite the direction of rotation of the wind turbine 150 about the turbine axis A.

While the wind turbines 110, 130, 140, 150 of FIGS. 7A-7D are shown having three inner blades 112 and three outer blades 114, it will be appreciated that various alternative quantities and corresponding circumferential arrangements of inner and outer blades 112, 114 may be provided in alternative embodiments. Additional concentric rings of outer blades may be provided in alternative embodiments as well, each separated by a circular border similar to border 116, for example.

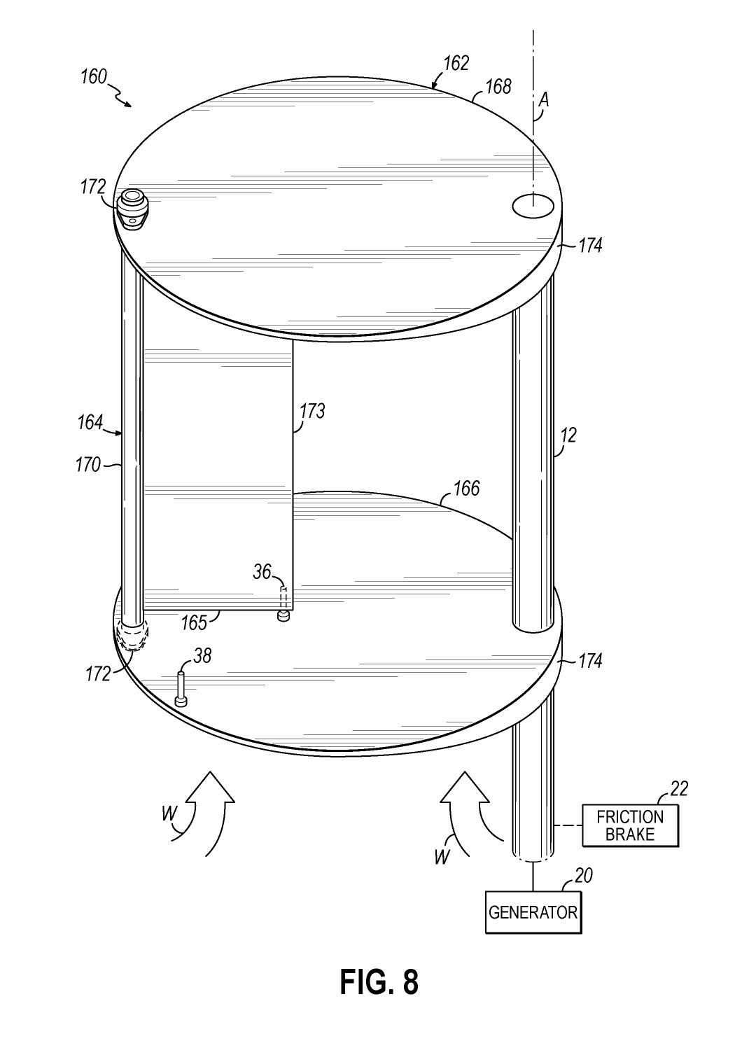

Referring to FIG. 8, a vertical axis wind turbine 160 according to another exemplary embodiment of the invention is shown. The wind turbine 160 generally includes a turbine shaft 12, a blade support structure 162 operatively coupled to the turbine shaft 12, and a single blade 164 operatively coupled to the support structure 162. The support structure 162 includes a lower support member shown in the form of a lower support disc 166, and an upper support member shown in the form of an upper support disc 168. The turbine shaft 12 defines a turbine axis A and includes a central portion that extends fully between the lower and upper support discs 166, 168, and a lower portion that extends outwardly from the lower support disc 166 and at which the wind turbine 160 may be mounted to an external structure.

Unlike the wind turbines of FIGS. 1-7D, the support structure 162 of wind turbine 160 is mounted to the turbine shaft 12 such that a central axis of the support structure 162 is offset from the turbine axis A. As shown in FIG. 8, the turbine shaft 12 extends through the support structure 162 near the radially outer edges of the lower and upper support discs 166, 168. The single blade 164 is mounted to the support structure 162 at a position generally diametrically opposite from the turbine shaft 12 and turbine axis A. The single blade 164 includes a blade strut 170 that extends between the lower and upper support discs 166, 168 in a direction generally parallel to the turbine axis A, and is pivotably mounted to the support discs 166, 168, for example with bearing units 172. The single blade 164 is mounted such that its free edge 173 is positioned radially inward of the blade strut 170, and is oriented toward the turbine axis A.

The single blade 164 is shown in an exemplary fixed working position at which the blade abuts and is restrained by a first blade stop member, shown in the form of working position pin 36. The wind turbine 160 may further include a second blade stop member, shown in the form of neutral position pin 38, for restraining the single blade 164 at a neutral position. The working position pin 36 and neutral position pin 38 function in the manner as described above in connection with FIGS. 1-1B. In that regard, the working position pin 36 restrains the single blade 164 at the exemplary working position shown, at which the single blade 164 receives a wind force and generates a torque to rotate the support structure 162 about the turbine axis A. Once the support structure 162 rotates more than 90 degrees past an orientation at which the single blade 164 is perpendicular to the wind direction, the wind W engages an opposite side of the single blade 164 and thereby forces the single blade 164 to pivot toward its neutral position. The single blade 164 pivots in the same rotational direction as the rotation of the support structure 162 about the turbine axis A. Advantageously, as described above, pivoting of the single blade 164 to its neutral position decreases generation of undesirable counter-torque that would otherwise oppose the torque generated by the single blade 164 at its fixed working position.

Because the blade strut 170 and the turbine shaft 12 are positioned at generally opposite sides of the support structure 162, the torque arm of the single blade 164 relative to the turbine axis A may be approximately twice that of either one of the blades 16, 18 of the wind turbine 10 of FIG. 1 formed with the same diameter. Accordingly, and advantageously, the single blade 164 may generate approximately twice the amount of torque generated by either one of the blades 16, 18, while incorporating fewer moving parts. In exemplary embodiments, the single blade 164 may be formed with a blade chord 165 that is less than or equal to a radius of the support structure 162. Further, the chord 165 and a span of the single blade 164 may be adjusted as desired to achieve various performance characteristics of the wind turbine 160.

As a result of the single blade 164 and support structure 162 being offset from the turbine axis A, they generate an unbalanced centrifugal force during rotation. To balance this centrifugal force and mitigate undesired vibrations of the wind turbine 160 during operation, the support structure 162 may be provided with one or more counterweight elements, shown in the form of thickened portions 174 having increased mass and formed integrally with the lower and upper support discs 166, 168. The thickened portions 174, or other counterweight elements, are provided at a circumferential location on support structure 162 that generally opposes the circumferential location at which the single blade 164 is mounted, so as to extend radially outward from an opposite side of the turbine shaft 12. It will be appreciated that the counterweigh elements may take various other forms suitable to offset the otherwise unbalanced centrifugal force generated by the single blade 164 and support structure 162 during rotation. Moreover, the counterweight elements may be formed integrally with or coupled to the support structure 162. The mass and positioning of the counterweight elements may be tuned as desired depending on the mounting location and dimensions of the single blade 164.

In the various embodiments shown and described herein, the geometric shape and mounting location of the wind turbine blades may be modified as desired to adjust certain performance characteristics of the wind turbine, including power generation and noise production. In various embodiments, the amounts of power and noise generated by a wind turbine may be determined by the speed at which the blades pivot about their blade axes, as well as the speed at which the wind turbine rotates about its turbine axis. In one exemplary wind turbine configuration, the blades may be shaped and mounted so as to maximize power generated by the wind turbine, without regard for noise reduction. In a second exemplary wind turbine configuration, the blades may be shaped and mounted so as to minimize noise production, without regard for power generation. In a third exemplary wind turbine configuration, the blades may be shaped and mounted so as to balance power generation with noise reduction.

Referring to FIG. 9, any one of the vertical axis wind turbines disclosed herein (indicated generically at 180), such as wind turbine 10 for example, may be rotatably mounted to and supported by an exemplary wind turbine support frame 182. The support frame 182 may be formed from a plurality of interconnected arm-like members defining a base portion 184 and a body portion 186 extending upwardly from the base portion 184. The base portion 184 may house a generator and a friction braking device (collectively indicated at 187) that engage a turbine shaft of the wind turbine 180. The body portion 186 may at least partially enclose the wind turbine 180 and may include a lower hub 188, supported by lower arms 190, that rotatably supports a lower portion of the wind turbine shaft, and optionally an upper hub 192, supported by upper arms 194, that rotatably supports an upper portion of the wind turbine shaft, for example using bearing units (not shown).

The support frame 182 may support the wind turbine 180 vertically such that the base portion 184 rests on a support surface, such as a ground surface or a building surface, for example. Alternatively, the support frame 182 may support the wind turbine 180 horizontally. For example, both the base portion 184 and the body portion 186 may be rested on a support surface, or the entire support frame 182 may be attached (e.g., at its ends) to an external structure that suspends the support frame 182 and the wind turbine 180 above a support surface. Moreover, while the support frame 182 is shown having a particular structural configuration, it will be appreciated that the support frame 182 may be formed with various alternative configurations suitable to support a vertical axis wind turbine according to any one of the exemplary embodiments of the invention.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A vertical axis wind turbine comprising:
a support structure rotatable about a turbine axis; and
at least two blades, each blade operatively coupled to the support structure and being pivotable about a respective blade axis,
wherein each of the at least two blades is pivotable between a fixed working position at which the blade receives a first amount of wind force and generates a torque for rotating the support structure about the turbine axis, and a neutral position at which the blade receives a lesser second amount of wind force.

2. The vertical axis wind turbine of claim 1, wherein the blade axes are spaced radially outward from the turbine axis.

3. The vertical axis wind turbine of claim 1, wherein the blade axes extend parallel to the turbine axis.

4. The vertical axis wind turbine of claim 1, further comprising:
at least two blade stop members operatively coupled to the support structure, each blade stop member configured to restrain a respective one of the at least two blades at the fixed working position.

5. The vertical axis wind turbine of claim 4, wherein the at least two blade stop members include pins.

6. The vertical axis wind turbine of claim 4, wherein the at least two blade stop members include tethers, each tether configured to restrain a respective one of the at least two blades at the fixed working position and at the neutral position.

7. The vertical axis wind turbine of claim 1, wherein each of the blades includes a free edge that extends away from the respective blade axis,
wherein for each of the at least two blades, the respective blade axis is spaced from the turbine axis such that when the blade is in the fixed working position the respective free edge is positioned radially inward of the respective blade axis.

8. The vertical axis wind turbine of claim 7, wherein the support structure includes a disc extending orthogonal to the turbine axis, and wherein each of the blades includes a blade strut pivotably coupled to the disc and defining a blade axis parallel to the turbine axis.

9. The vertical axis wind turbine of claim 1, wherein each of the blades includes a free edge that extends away from the respective blade axis,
wherein for each of the at least two blades, the respective blade axis is positioned relative to the turbine axis such that when the blade is in the fixed working position the respective free edge is positioned radially outward of the respective blade axis.

10. The vertical axis wind turbine of claim 9, wherein the support structure includes a central shaft extending coaxially with the turbine axis, and the at least two blades are supported by the central shaft.

11. The vertical axis wind turbine of claim 1, wherein each of the at least two blades pivots about its respective blade axis from the fixed working position to the neutral position in a direction opposite of the direction of rotation of the support structure about the turbine axis.

12. The vertical axis wind turbine of claim 1, wherein the at least two blades includes a plurality of inner blades circumferentially spaced about the turbine axis, and a plurality of outer blades positioned radially outward of the inner blades and circumferentially spaced about the turbine axis, wherein
the plurality of inner blades includes at least three inner blades, each of the inner blades being pivotable about a respective inner blade axis,
the plurality of outer blades includes at least three outer blades, each of the outer blades being pivotable about a respective outer blade axis.

13. The vertical axis wind turbine of claim 12, wherein at least one of the plurality of inner blades or the plurality of outer blades is mounted to the support structure such that free edges of the at least one plurality of blades are positioned radially inward of their respective blade axes when the blades are in their fixed working positions.

14. The vertical axis wind turbine of claim 12, wherein at least one of the plurality of inner blades or the plurality of outer blades is mounted to the support structure such that free edges of the at least one plurality of blades are positioned radially outward of their respective blade axes when the blades are in their fixed working positions.

15. The vertical axis wind turbine of claim 1, wherein the at least two blades include flat plates.

16. The vertical axis wind turbine of claim 1, further comprising:
at least one solar panel mounted to the vertical axis wind turbine.

17. A vertical axis wind turbine comprising:
a support structure rotatable about a turbine axis;
a single blade coupled to the support structure and being pivotable about a blade axis between a fixed working position at which the single blade receives a first amount of wind force and generates a torque for rotating the support structure about the turbine axis, and a neutral position at which the single blade receives a lesser second amount of wind force; and
a counterweight coupled to the support structure and adapted to offset a centrifugal force generated by the single blade during rotation of the support structure about the turbine axis.

18. A method of aerodynamically braking a vertical axis wind turbine, the method comprising:
obtaining a vertical axis wind turbine including a support structure rotatable about a turbine axis, and at least one blade operatively coupled to the support structure and pivotable about a blade axis between a fixed working position at which the at least one blade is configured to receive a first amount of wind force and generate a torque for rotating the support structure about the turbine axis, and a neutral position at which the at least one blade is configured to receive a lesser second amount of wind force; and
braking rotation of the support structure about the turbine axis by at least one of:
inhibiting the at least one blade from reaching the fixed working position, such that the at least one blade generates substantially no torque about the turbine axis, or
securing the at least one blade in a position other than the neutral position so as to inhibit the at least one blade from generating a net torque about the turbine axis.

19. The method of claim 18, wherein the vertical axis wind turbine further includes a blade stop member operatively coupled to the support structure and configured to restrain the at least one blade at the fixed working position, and
wherein inhibiting the at least one blade from reaching the fixed working position includes manipulating the blade stop member so as to no longer restrain the at least one blade at the fixed working position.

20. The method of claim 18, wherein securing the at least one blade in a position other than the neutral position includes restraining the at least one blade at the fixed working position with the blade stop member.
